(19) United States
(12) Patent Application Publication
(10) Pub. No.: US 2007/0170205 A1
(43) Pub. Date: Jul. 26, 2007

(54) Extension sprayer

(76) Inventors: Jeffrey Thomas Walker, West Bloomfield, MI (US); Esther Marina Walker, West Bloomfield, MI (US)

Correspondence Address: SHOEMAKER AND MATTARE, LTD, 10 POST OFFICE ROAD - SUITE 110, SILVER SPRING, MD, 20910, US

(21) Appl. No.: 11/337,533

(22) Filed: Jan. 24, 2006

(51) Int. Cl. B67D 5/64

(52) U.S. Cl. 222/174; 222/402.15

(57) ABSTRACT

A flexible spray can holder to allows for the extension of a spray can away from user and applied remotely. The trigger of the device is designed to adapt to various cap designs found on the market to allow for application while mounted on a common extension pole or broom handle. The device can be held at a variety of distances from the user due to the use of string to apply the trigger.

### BACKGROUND OF THE INVENTION

This invention generally relates to a tool for extending one's reach when operating spray or aerosol cans.

Most spray cans, one of which is illustrated in FIG. 1, have a pressurized container filled with a liquid to be dispensed and a compressed gas or propellant to eject the liquid. A spray head, having an aerosol generating nozzle, is mounted on the upper end of the pressure container. The lower end of the spray head is connected to a valve contained in the pressure container, by means of a stem which opens the valve when the spray head is depressed.

Prior inventors have developed pole pruners and similar extension tools which enable one to engage objects which are normally out of reach. Such tools have also been proposed for operating aerosol cans, such as those containing insecticide or paint.

A problem with prior devices is that—besides being too complicated in many cases—they are for the most part not adaptable to spray cans having differently designed spray heads, including ones that are shielded or covered, or to cans of different heights or diameters.

### SUMMARY OF THE INVENTION

An object of the invention is to provide a versatile device for triggering spray cans of different sizes, and spray head designs, while enabling a user to operate them at positions normally out of reach.

The inventive device can be mounted on a common broom stick or a readily available extension pole.

Since the device enables a user to hold spray cans at various distances to get closer to a target object, the user can avoid climbing a dangerous ladder, or getting too near stinging insects. Simultaneously, the user can more accurately dispense contents of spray can to avoid fallout, waste, and possible damage due to overspray.

The spray can is operated by pulling on a common string with one hand, while the extension pole is held in the other. The string pivots a trigger (or “actuating lever”), causing it to depress the spray head and dispense the contents. The finger that actuates the can is designed to maximize adaptability to various types of spray head designs.

The device is screwed on a standard thread design found on most extension poles and broom sticks, so no dedicated or integral pole is required. By using string instead of more elaborate linkage the invention can be held at various distances by using different string lengths while still using a standard extension pole.

### BRIEF DESCRIPTION OF THE DRAWINGS

In the drawings,

FIG. 1 is a perspective view of conventional aerosol spray can;

FIG. 2 is a perspective view, from the front and above, of a device embodying the invention;

FIG. 3 is a perspective view thereof, from the rear and above;

FIG. 4 is a perspective view thereof, from the front and below; and

FIG. 5 is a side elevation thereof, with part of the body broken away to show internal detail.

### DETAILED DESCRIPTION OF THE PREFERRED EMBODIMENTS

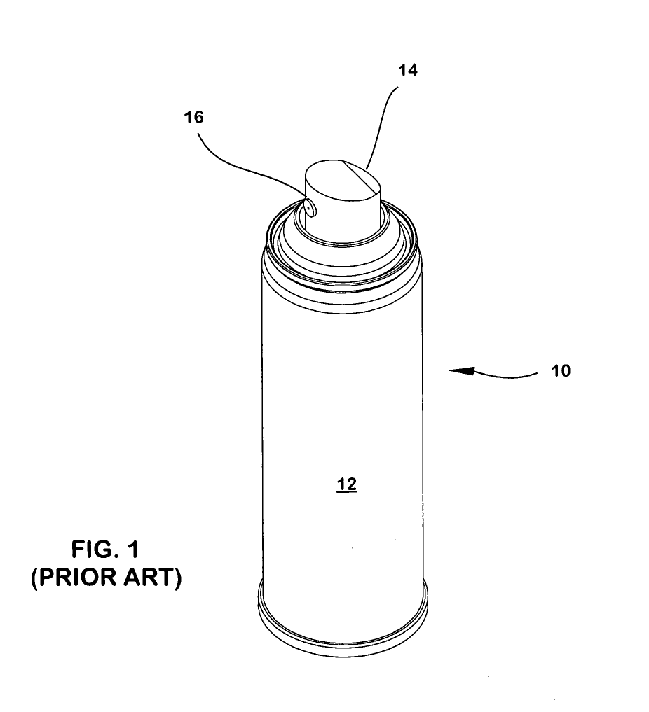

FIG. 1 shows a conventional spray can 10 of the type used to contain, for example, insecticide or paint. The spray can includes a cylindrical container 12, and a spray head 14 having a stem which extends into an opening at the top of the can and releases a valve (not shown) when the spray head is depressed sufficiently. Liquid contents under pressure then are discharged through a nozzle 16 which typically is designed to generate an aerosol spray. Such cans come in many shapes and sizes, and there are a variety of spray head designs. In short, there is no standard aerosol spray can.

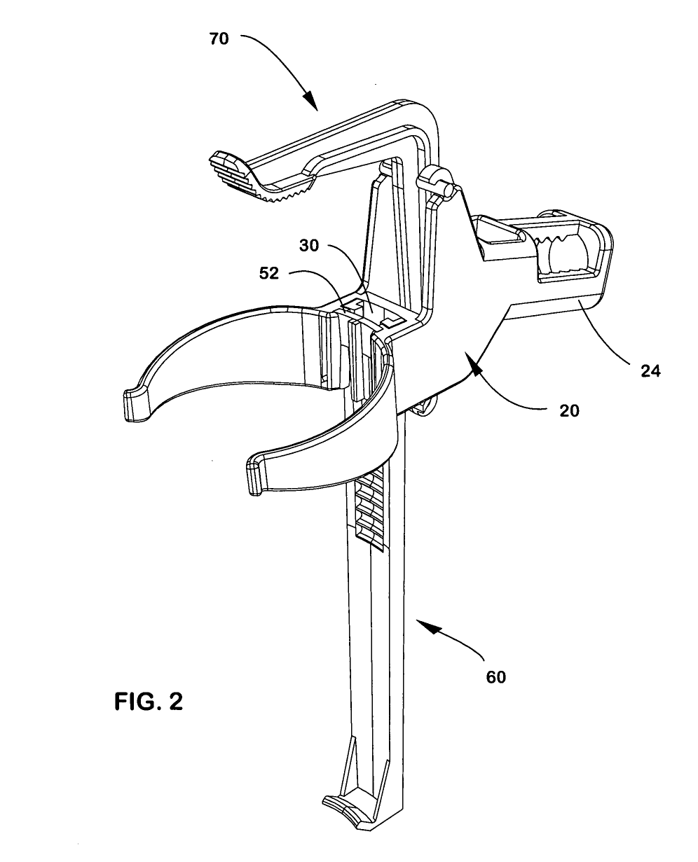

FIGS. 2-4 show, from different viewpoints, a spray can reach extender device constructed according to this invention. Referring to FIG. 2, the device includes three parts: a body portion 20, a can support 60 and an actuating lever 70.

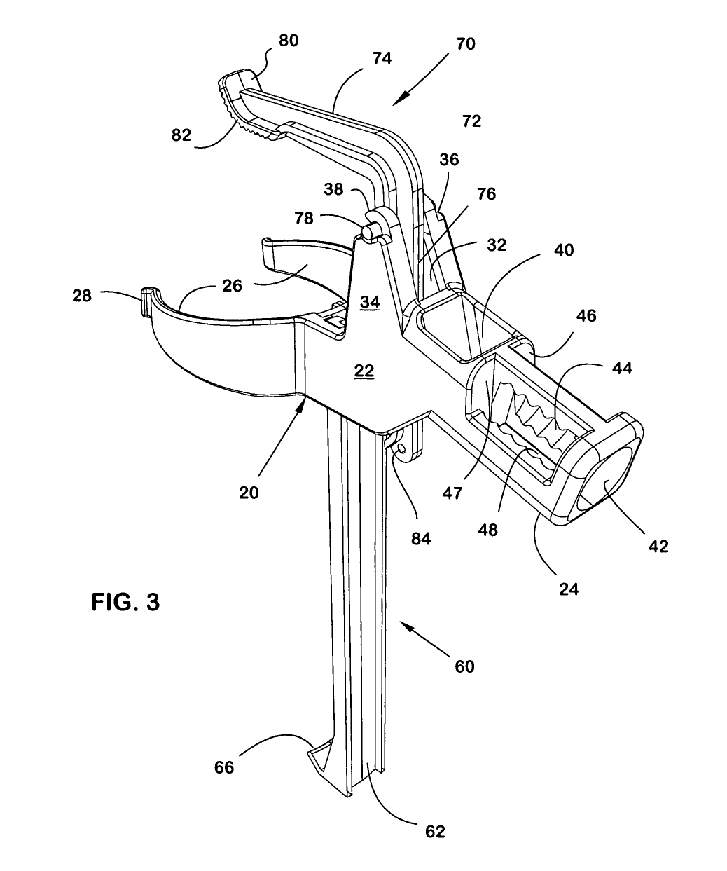

As shown in FIG. 3, the body part 20 has a central portion 22 from which a pole socket 24 extends in a rearward direction, and a pair of flexible arcuate arms 26 extend in a forward direction. Each arm terminates at an out-turned tip 28. The arms straddle a forward vertical channel 30 (FIG. 2) which receives the can support as described later. A central vertical through aperture 32 extends generally parallel to the forward channel. The upper end of the central aperture opens into the space between a pair of bearings 34 having pivot seats 36 and a uppermost retaining hook 38.

The recess 40 (FIG. 3) between the channel 30 and the poles socket 24 lightens the structure. The pole socket itself has a bore 42 sized to receive a threaded broomstick, for example. The bore has interrupted internal threads 44 of complementary design. Three windows 46,47,48 remove unnecessary weight from the design and simplify molding of the threads. The way in which the threads are molded is described later in the description.

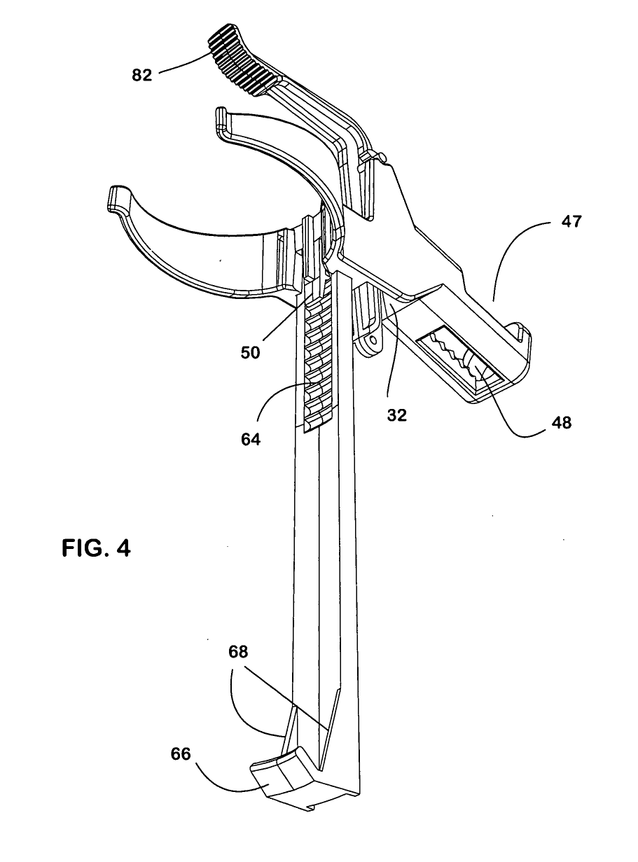

In FIG. 4, one sees a resilient pawl 50. The pawl is supported by a pair of tabs 52 (FIG. 2) spanning the front of the channel 30. The tabs 52 can flex somewhat to allow the pawl to oscillate slightly about the pivot axis defined by the tabs.

The can support 60 is a vertical, elongate member sized to slide in the channel 30. It has a groove 62 (FIG. 3) extending the length of its rear surface, and a series of ratchet teeth 64 (FIG. 4) formed in its front surface. When the can support is inserted in the forward channel 30, the pawl engages between two adjacent ratchet teeth to hold the support in position. At the bottom of the can support is a finger 66, directed obliquely upward and forward, to engage beneath the bottom rim of a spray can. The tip of the finger is rounded in profile view. Gussets 68 reinforce the finger.

The actuating lever 70 has an elbow 72 at the juncture of its upper end 74 and its lower end 76. Just below the elbow, pivot pins 78 extend to either side. The pins are sized to bear on the pivot seats 36, and are a bit larger than the space between the seats and the leading edges of the retaining hooks 38 that they can be snapped into the seated position and are thereafter retained in that position by the hooks.

The upper end 74 of the actuating lever terminates at a pad 80 having a convexly rounded lower surface. The surface is interrupted by a series of transverse teeth or ribs 82 designed to engage the top of the spray can head, and to depress it when the lever is actuated.

The lower end 76 of the lever extends through the central aperture 30, terminating at a spot beneath the socket 24 and behind the can support 60. The transverse through hole 84 is provided to receive one end of an actuating cord or string (not shown).

One prepares the device for use by inserting a spray can (with its nozzle facing forward) between the arms, and then adjusting the can support so that the finger is beneath the bottom rim of the can and the spray head is in the path of the ribbed surface of the actuating lever. Ideally, the top of the spray head should be about level with the pivot pins so that there is not a lot of rubbing contact between the ribs and the spray head during operation.

Now one can insert an extension pole into the socket, hold the pole in one hand and the string in the other, raise the can near the target location, and spray the target with the contents of the container by pulling the string. The string remains out of contact with the pole or the reach extender, thus avoiding abrasion, drag, and the possibility of becoming caught or out of place.

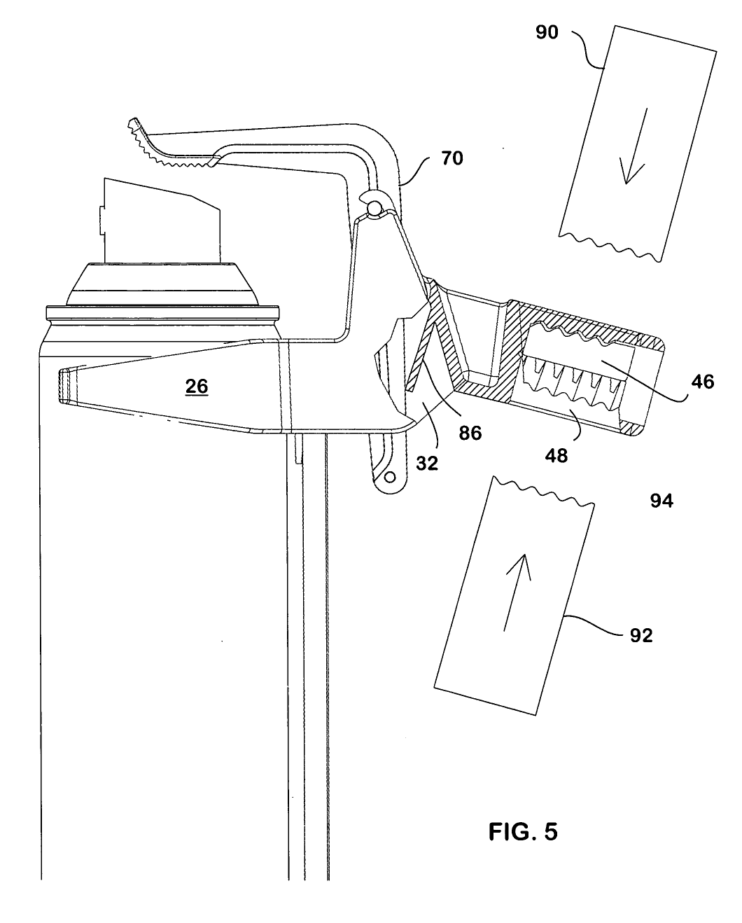

FIG. 5 shows another embodiment in which the body has a flap 86 molded inside the aperture, to function as a return spring that moves the lever 70 off the can after activation. This may help in cases where the spray cans trigger may be prone to catch on the trigger.

FIG. 5 also shows a simple method of forming the internal threads in the socket. In this method, the threads are formed by dies 90,92 having thread-forming ends 94 which are inserted into the molding cavity as the piece is being formed. The dies, when withdrawn in a radial direction, also form the windows 46,47,48 opposite each thread segment. It will be appreciated that this method could be practiced with any number of thread-forming dies greater than one (three, in the illustrated example). It is also possible that the threads could be formed after the part was molded, by heating the dies to a sufficient temperature, considering the thermoplastic being used, then inserting them in a radial direction through pre-formed windows, to contact the walls segments opposite the windows and produce threads on those segments.

Various modifications of the preferred embodiment described above are possible. For example, the holder 12 could be modified by adding a device such as a screw or clamp to the retaining arms, the device being adapted to secure the can to the arms, thus avoiding the need for a can retainer.

The contact design of the trigger also could be modified as needed to adapted to new cap designs as they are brought to market.

Furthermore, the trigger could be modified to mount on top of the main body, rather than extending through it, to provide decreased packaging volume.

The device could be provided with a cup for holding the can, in which case the trigger mechanism could be riveted or molded onto the cup

Also, the hook that holds the bottom of the spray can could be made out of various materials such as stamped metal or thick gage wire. In general, the choice of material and manufacturing method for each component should be a matter of choice for the designer.

Inasmuch as the foregoing description and the drawings describe preferred examples of the invention, which is subject to many variations and modification, I intend that the invention should be defined only by the following claims.

I claim:

1. A device for supporting and operating an aerosol container and adapted to mount at the end of an extension pole, said device comprising
a body portion having means for grasping aerosol containers of different diameters and a socket for receiving an end of an extension pole,
a container bottom support adjustably supported by the body portion so as to support aerosol cans of different heights, and
an actuating lever pivotally connected to the body portion.

2. The invention of claim 1, wherein the grasping means comprises a pair of flexible arcuate arms extending forward from the body.

3. The invention of claim 1, wherein each arm terminates at an out-turned tip.

4. The invention of claim 1, wherein the body defines a channel, and the container bottom support is adjustably supported within the channel.

5. The invention of claim 1, wherein the body defines a vertical through aperture extending generally parallel to the channel, and the lever comprises a lower portion which extends through the aperture.

6. The invention of claim 1, wherein the body comprises a pair of bearings having pivot seats and the lever has a pivot pin which rests upon the seats.

7. The invention of claim 1, wherein a retaining hook overlying each seat to retain the pivot pin on the seats.

8. The invention of claim 1, wherein the socket has a bore sized to receive an end of the extension pole.

9. The invention of claim 1, wherein the bore has interrupted internal threads for receiving a threaded pole end.

10. The invention of claim 1, wherein the socket has plural windows intersecting the bore and interrupting the threads.

11. The invention of claim 1, further comprising a pawl mounted for limited pivoting movement on the body, adapted to engage the support.

12. The invention of claim 1, wherein the support has a series of teeth formed thereon, for engagement by the pawl.

13. The invention of claim 1, wherein the teeth are symemetrical so that they resist, but permit, sliding movement of the support in either direction.

14. The invention of claim 1, wherein the support has a finger at its lower end, directed obliquely upward and forward, to engage beneath the bottom rim of the container.

15. The invention of claim 1, wherein the actuating lever has an upper end and a lower end, and an elbow at the juncture of its upper end and its lower end.

16. The invention of claim 1, wherein the upper end of the actuating lever terminates at a pad having a convexly rounded lower surface adapted to engage the top of the spray head, and to depress it when the lever is actuated.

17. The invention of claim 1, wherein the rounded lower surface of the pad is serrated

18. The invention of claim 1, wherein the lower end of the lever has a transverse through hole adapted to receive one end of an actuating cord or string whereby the spray head may be depressed remotely by pulling on the string when an aerosol can is supported by the body.

19. A method of forming segmented internal screw threads in a cylindrical socket, said method comprising steps of
providing plural dies, each having a thread segment-forming surface thereon;
molding the socket around the dies; and then
with drawing the dies, leaving the socket with plural thread segments opposite a like number of windows between the segments.

20. A method of forming segmented internal screw threads in a cylindrical socket, said method comprising steps of
providing plural dies, each having a thread segment-forming surface thereon;
molding a socket from a plastic material in a mold designed to produce plural windows in the circumference of the socket; and then
inserting the dies through the windows so that their thread segment-forming surfaces contact wall portions of the socket opposite the windows, at a temperature/force sufficient to deform the plastic material, then
withdrawing the dies through the windows.
